(19) United States
(12) Patent Application Publication
(10) Pub. No.: US 2026/0092851 A1
(43) Pub. Date: Apr. 2, 2026

(54) RHEOMETER CONTROL AND INTERFACE

(71) Applicant: TA Instruments-Waters LLC, New Castle, DE (US)

(72) Inventors: James Wondrack, Pittsford, NY (US); Sarah Cotts, West Chester, PA (US); Eugene Dudley, Newark, DE (US); Cynthia Waters, West Grove, PA (US); Christopher Ubelacker, West Chester, PA (US)

(21) Appl. No.: 19/341,342

(22) Filed: Sep. 26, 2025

Related U.S. Application Data
(60) Provisional application No. 63/699,898, filed on Sep. 27, 2024.

(51) Int. Cl. G01N 11/14; G01N 11/00

(52) U.S. Cl. CPC G01N 11/142; G01N 2011/0006

(57) ABSTRACT

Disclosed are methods of controlling a rheometer. Methods include receiving, by a control device, an operating procedure for a test, the operating procedure including a plurality of sequential steps for performing the test and controlling the rheometer according to the operating procedure to perform the test. Controlling includes sequentially presenting, to a user of the rheometer, the plurality of sequential steps, determining whether the operating procedure has been met for a respective sequential step of the plurality of sequential steps for performing the test, and proceeding to a subsequent step of the plurality of sequential steps for performing the test only when the operating procedure has been met for the respective sequential step.

Rheological systems, control devices for a rheometer, and computer program products that implement methods of controlling a rheometer are also disclosed.

### RELATED APPLICATIONS

This application claims priority to U.S. provisional Ser. No. 63/699,898 filed Sep. 27, 2024 and titled “Rheometer Control and Interface,” the contents of which are incorporated by reference in their entirety.

### FIELD OF THE INVENTION

The invention relates generally to rheometers, rheological measurement systems, and related control devices. More particularly, the invention relates to rheological system having a rheometer and a control device for controlling the rheometer.

### BACKGROUND

Rheology is the study of how matter flows or deforms, for example, in response to a force. Rheometers are instruments used to characterize rheological properties of materials such as oils, dispersions, suspensions, emulsions, adhesives, biological fluids, polymers, gels, pastes, slurries, melts, resins, powders, foams, or mixtures of the foregoing. As used herein, the term “rheometer” shall include rheometers, viscometers, viscosimeters, and any other instrument that may be used to measure the rheological and/or viscoelastic properties of fluids or powders. The term “rheological system” may include a rheometer as defined. Further, a rheological system may include a control device for controlling the rheometer.

The use of rheological systems and/or rheometers may be referred to as “rheology workflow.” Rheology workflow is often complex. Accordingly, rheology workflow may require substantial training. However, even with substantial training, rheology workflow remains challenging, there is a high risk of operator error, deviations from standard operating procedures often occur, and data validity may be comprised. Further, analysis of completed workflow is complex, requiring expertise to accurately extract information, diagnose issues, and determine whether samples pass/fail respective tests.

Thus, rheological systems and rheometers that provide for improved rheology workflow and reduced error rate would be well received in the art.

### SUMMARY

In an embodiment, a method of controlling a rheometer comprises receiving, by a control device, an operating procedure for a test, the operating procedure including a plurality of sequential steps for performing the test; and controlling the rheometer according to the operating procedure to perform the test. Controlling includes sequentially presenting, to a user of the rheometer, the plurality of sequential steps, determining whether the operating procedure has been met for a respective sequential step of the plurality of sequential steps for performing the test, and proceeding to a subsequent step of the plurality of sequential steps for performing the test only when the operating procedure has been met for the respective sequential step.

Additionally or alternatively, controlling the rheometer according to the operating procedure to perform the test further includes providing a warning, an error message, and/or an alert when the operating procedure has not been met for the respective sequential step.

Additionally or alternatively, controlling the rheometer according to the operating procedure to perform the test further includes preventing the rheometer from continuing to a subsequent step of the plurality of sequential steps for performing the test when the operating procedure has not been met for the respective sequential step.

Additionally or alternatively, the method further comprises terminating the test.

Additionally or alternatively, terminating the test is only performed when the control device determines the operating procedure has been met for all respective sequential steps of the plurality of sequential steps for performing the test.

In another embodiment, a rheological system comprises a rheometer and a control device for controlling the rheometer according to an operating procedure to perform a test, the control device including one or more processors. The control device is configured to receive the operating procedure for the test, the operating procedure including a plurality of sequential steps for performing the test, sequentially present, to a user of the rheometer, the plurality of sequential steps, determine whether the operating procedure has been met for a respective sequential step of the plurality of sequential steps for performing the test, and proceed to a subsequent step of the plurality of sequential steps for performing the test only when the operating procedure has been met for the respective sequential step.

Additionally or alternatively, when the operating procedure has not been met for the respective sequential step, the control device is configured to provide a warning, an error message, and/or an alert to the user.

Additionally or alternatively, when the operating procedure has not been met for the respective sequential step, the control device is configured to prevent the rheometer and/or the user from continuing to a subsequent step of the plurality of sequential steps for performing the test.

Additionally or alternatively, the control device is further configured to terminate the test.

Additionally or alternatively, the control device is configured to terminate the test only when the control device determines the operating procedure has been met for all respective sequential steps of the plurality of sequential steps for performing the test.

Additionally or alternatively, the operating procedure includes an expected geometry of a sample plate for the test, wherein the rheometer and/or the control device are configured to detect an actual geometry of the sample plate, and wherein the control device is also configured to perform at least one action selected from the group consisting of present to the user a subsequent step of the plurality of sequential steps only when the actual geometry matches the expected geometry; provide a warning, an error message, and/or an alert to the user when the actual geometry does not match the expected geometry; and prevent the rheometer and/or the user from continuing to a subsequent step of the plurality of sequential steps for performing the test when the actual geometry does not match the expected geometry.

Additionally or alternatively, the operating procedure includes a calibration schedule for the rheometer and/or the rheological system and wherein the control device is also configured to perform at least one action selected from the group consisting of prevent the rheometer and/or the user from continuing to a subsequent step of the plurality of sequential steps for performing the test until calibration is performed according to the calibration schedule; present to the user a subsequent step of the plurality of sequential steps only when calibration is successfully performed according to the calibration schedule; provide a warning, an error message, and/or an alert to the user when calibration is not performed according to the calibration schedule; and prevent the rheometer and/or the user from continuing to a subsequent step of the plurality of sequential steps for performing the test when calibration is not performed according to the calibration schedule.

Additionally or alternatively, the operating procedure for the test further includes pass/fail criteria for the test, wherein the control device is configured to automatically determine a pass/fail result of the test based on the pass/fail criteria for the test, and wherein the control device is configured to provide the automatically determined pass/fail result of the test to the user.

Additionally or alternatively, the operating procedure for the test includes a sample loading requirement for a sample of the test and wherein the control device is also configured to perform at least one action selected from the group consisting of prevent the rheometer and/or the user from continuing to a subsequent step of the plurality of sequential steps for performing the test until the sample is loaded according to the sample loading requirement for the test; present to the user a subsequent step of the plurality of sequential steps only when the sample is properly loaded according to the sample loading requirement for the test; provide a warning, an error message, and/or an alert to the user when the sample is not loaded and/or is not loaded according to the sample loading requirement; and prevent the rheometer and/or the user from continuing to a subsequent step of the plurality of sequential steps for performing the test when the sample is not loaded and/or is not loaded according to the sample loading requirement.

Additionally or alternatively, the operating procedure for the test includes a cleaning requirement for the test and wherein the control device is also configured to perform at least one action selected from the group consisting of prevent the rheometer and/or the user from continuing to a subsequent step of the plurality of sequential steps for performing the test and/or from completing the test until the cleaning requirement for the test is met; present to the user a subsequent step of the plurality of sequential steps and/or an option to complete the test only when the cleaning requirement for the test is met; provide a warning, an error message, and/or an alert to the user when the cleaning requirement for the test is not met; and prevent the rheometer and/or the user from continuing to a subsequent step of the plurality of sequential steps for performing the test and/or from completing the test when the cleaning requirement for the test is not met.

Additionally or alternatively, the rheometer and/or the control device are configured to detect a force on the rheometer or a component of the rheometer, wherein the control device is configured to compare the force with a predefined threshold, and wherein when the force exceeds the predefined threshold the control device is configured to provide a warning, an error message, and/or an alert to the user.

Additionally or alternatively, the rheometer and/or the control device are configured to detect a height position of a component of the rheometer, wherein the control device is configured to compare the height position with a predefined value, and wherein when the height position deviates from the predefined value the control device is configured to provide a warning, an error message, and/or an alert to the user.

Additionally or alternatively, the operating procedure includes an expected geometry of a sample plate for the test, wherein the rheometer and/or the control device are configured to detect an actual geometry of the sample plate, wherein the operating procedure for the test also includes a sample loading requirement for a sample of the test to be loaded on the sample plate for the test, and wherein the control device is also configured to perform at least one action selected from the group consisting of prevent the rheometer and/or the user from continuing to a subsequent step of the plurality of sequential steps for performing the test unless the actual geometry matches the expected geometry and the sample is loaded according to the sample loading requirement for the test; present to the user a subsequent step of the plurality of sequential steps only when the actual geometry matches the expected geometry and the sample is properly loaded according to the sample loading requirement for the test; provide a warning, an error message, and/or an alert to the user when the actual geometry does not match the expected geometry or the sample is not loaded according to the sample loading requirement; and prevent the rheometer and/or the user from continuing to a subsequent step of the plurality of sequential steps for performing the test when the actual geometry does not match the expected geometry or the sample is not loaded according to the sample loading requirement.

Additionally or alternatively, the operating procedure for the test includes a cleaning requirement for the test, wherein the cleaning requirement includes a height requirement of a component of the rheometer, wherein the rheometer and/or the control device are configured to detect a height of the component and a force on the rheometer or the component, and wherein the control device is also configured to determine that a sample has become stuck based on the height of the component and the force on the rheometer or the component, provide a warning, an error message, and/or an alert to the user, wherein the warning, error message, and/or alert include instructions for further cleaning to clean the sample that has become stuck.

In another embodiment, a rheological system comprises a rheometer and a control device, the control device including one or more processors, the control device configured to receive an operating procedure for a test, the operating procedure including a plurality of sequential steps for performing the test, sequentially present, to a user of the rheometer, the plurality of sequential steps, and control the rheometer according to the operating procedure to perform the test.

Additionally or alternatively, the control device is configured to determine whether the operating procedure has been met for a respective sequential step of the plurality of sequential steps for performing the test.

Additionally or alternatively, the control device is configured to present to the user a subsequent step of the plurality of sequential steps for performing the test only when the operating procedure has been met for the respective sequential step.

Additionally or alternatively, when the operating procedure has not been met for the respective sequential step, the control device is configured to provide a warning, an error message, and/or an alert to the user.

Additionally or alternatively, when the operating procedure has not been met for the respective sequential step, the control device is configured to prevent the rheometer and/or the user from continuing to a subsequent step of the plurality of sequential steps for performing the test.

Additionally or alternatively, the control device is configured to terminate the test.

Additionally or alternatively, terminating the test is only performed when the control device determines the operating procedure has been met for all respective sequential steps of the plurality of sequential steps for performing the test.

Additionally or alternatively, the operating procedure includes an expected geometry of a sample plate for the test.

Additionally or alternatively, the rheometer and/or the control device are configured to detect an actual geometry of the sample plate.

Additionally or alternatively, control device is further configured to present to the user a subsequent step of the plurality of sequential steps only when the actual geometry matches the expected geometry.

Additionally or alternatively, when the actual geometry does not match the expected geometry, the control device is configured to provide a warning, an error message, and/or an alert to the user.

Additionally or alternatively, when the actual geometry does not match the expected geometry, the control device is configured to prevent the rheometer and/or the user from continuing to a subsequent step of the plurality of sequential steps for performing the test.

Additionally or alternatively, the operating procedure includes a calibration schedule for the rheometer and/or the rheological system.

Additionally or alternatively, the control device is configured to prevent the rheometer and/or the user from continuing to a subsequent step of the plurality of sequential steps for performing the test until calibration is performed according to the calibration schedule.

Additionally or alternatively, the control device is further configured to present to the user a subsequent step of the plurality of sequential steps only when calibration is successfully performed according to the calibration schedule.

Additionally or alternatively, when calibration is not performed according to the calibration schedule, the control device is configured to provide a warning, an error message, and/or an alert to the user.

Additionally or alternatively, when calibration is not performed according to the calibration schedule, the control device is configured to prevent the rheometer and/or the user from continuing to a subsequent step of the plurality of sequential steps for performing the test.

Additionally or alternatively, the operating procedure for the test further includes pass/fail criteria for the test.

Additionally or alternatively, the control device is configured to automatically determine a pass/fail result of the test based on the pass/fail criteria for the test.

Additionally or alternatively, the control device is configured to provide the automatically determined pass/fail result of the test to the user.

Additionally or alternatively, the operating procedure for the test includes a sample loading requirement for the test.

Additionally or alternatively, the sample loading requirement includes a trimming requirement, a gap control requirement, and/or a cover requirement for the test.

Additionally or alternatively, the control device is configured to prevent the rheometer and/or the user from continuing to a subsequent step of the plurality of sequential steps for performing the test until a sample is loaded according to the sample loading requirement for the test.

Additionally or alternatively, the control device is further configured to present to the user a subsequent step of the plurality of sequential steps only when a sample is properly loaded according to the sample loading requirement for the test.

Additionally or alternatively, when a sample is not loaded and/or is not loaded according to the sample loading requirement, the control device is configured to provide a warning, an error message, and/or an alert to the user.

Additionally or alternatively, when a sample is not loaded and/or is not loaded according to the sample loading requirement, the control device is configured to prevent the rheometer and/or the user from continuing to a subsequent step of the plurality of sequential steps for performing the test.

Additionally or alternatively, the operating procedure for the test includes a cleaning requirement for the test.

Additionally or alternatively, the control device is configured to prevent the rheometer and/or the user from continuing to a subsequent step of the plurality of sequential steps for performing the test and/or from completing the test until the cleaning requirement for the test is met.

Additionally or alternatively, the control device is further configured to present to the user a subsequent step of the plurality of sequential steps and/or an option to complete the test only when the cleaning requirement for the test is met.

Additionally or alternatively, when the cleaning requirement for the test is not met, the control device is configured to provide a warning, an error message, and/or an alert to the user.

Additionally or alternatively, when the cleaning requirement for the test is not met, the control device is configured to prevent the rheometer and/or the user from continuing to a subsequent step of the plurality of sequential steps for performing the test and/or from completing the test.

Additionally or alternatively, the rheometer and/or the control device are configured to detect a force on the rheometer or a component of the rheometer.

Additionally or alternatively, the control device is configured to compare the force with a predefined threshold.

Additionally or alternatively, when the force exceeds the predefined threshold the control device is configured to provide a warning, an error message, and/or an alert to the user.

Additionally or alternatively, the rheometer and/or the control device are configured to detect a height position of a component of rheometer.

Additionally or alternatively, the control device is configured to compare the height position with a predefined value.

Additionally or alternatively, when the height position deviates from the predefined value the control device is configured to provide a warning, an error message, and/or an alert to the user.

Additionally or alternatively, the predefined value includes a motor force.

Additionally or alternatively, the rheological system further comprises a touchscreen display.

Additionally or alternatively, the operating procedure is input by a user.

Additionally or alternatively, the operating procedure is input by an individual other than the user.

In another embodiment, a method of controlling a rheometer comprises receiving, by a control device, an operating procedure for a test, the operating procedure including a plurality of sequential steps for performing the test; and controlling the rheometer according to the operating procedure to perform the test.

Additionally or alternatively, the method further comprises sequentially presenting, to a user of the rheometer, the plurality of sequential steps.

Additionally or alternatively, the method further comprises determining whether the operating procedure has been met for a respective sequential step of the plurality of sequential steps for performing the test.

Additionally or alternatively, the method further comprises proceeding to a subsequent step of the plurality of sequential steps for performing the test only when the operating procedure has been met for the respective sequential step.

Additionally or alternatively, the method further comprises providing a warning, an error message, and/or an alert when the operating procedure has not been met for the respective sequential step.

Additionally or alternatively, the method further comprises preventing the rheometer from continuing to a subsequent step of the plurality of sequential steps for performing the test when the operating procedure has not been met for the respective sequential step.

Additionally or alternatively, the method further comprises terminating the test.

Additionally or alternatively, terminating the test is only performed when the control device determines the operating procedure has been met for all respective sequential steps of the plurality of sequential steps for performing the test.

In a further embodiment, a control device for a rheometer comprises one or more processors; one or more computer readable storage devices coupled to the one or more processors, wherein the one or more storage devices contain program code executable by the one or more processors to implement a method for controlling the rheometer, the method comprising receiving an operating procedure for a test, the operating procedure including a plurality of sequential steps for performing the test; and controlling the rheometer according to the operating procedure to perform the test.

Additionally or alternatively, the control device further comprises sequentially presenting, to a user of the rheometer, the plurality of sequential steps.

Additionally or alternatively, the control device further comprises determining whether the operating procedure has been met for a respective sequential step of the plurality of sequential steps for performing the test.

Additionally or alternatively, the control device further comprises proceeding to a subsequent step of the plurality of sequential steps for performing the test only when the operating procedure has been met for the respective sequential step.

Additionally or alternatively, the control device further comprises providing a warning, an error message, and/or an alert when the operating procedure has not been met for the respective sequential step.

Additionally or alternatively, the control device further comprises preventing the rheometer from continuing to a subsequent step of the plurality of sequential steps for performing the test when the operating procedure has not been met for the respective sequential step.

Additionally or alternatively, the control device further comprises terminating the test.

Additionally or alternatively, terminating the test is only performed when the control device determines the operating procedure has been met for all respective sequential steps of the plurality of sequential steps for performing the test.

In a further embodiment, a computer program product, comprises a computer readable hardware storage device storing a computer readable program code, the computer readable program code comprising an algorithm that when executed by a computer processor of a computing system, implements a method for controlling a rheometer, the method comprising receiving an operating procedure for a test, the operating procedure including a plurality of sequential steps for performing the test; and controlling the rheometer according to the operating procedure to perform the test.

Additionally or alternatively, the method further includes sequentially presenting, to a user of the rheometer, the plurality of sequential steps.

Additionally or alternatively, the method further includes determining whether the operating procedure has been met for a respective sequential step of the plurality of sequential steps for performing the test.

Additionally or alternatively, the method further includes proceeding to a subsequent step of the plurality of sequential steps for performing the test only when the operating procedure has been met for the respective sequential step.

Additionally or alternatively, the method further includes providing a warning, an error message, and/or an alert when the operating procedure has not been met for the respective sequential step.

Additionally or alternatively, the method further includes preventing the rheometer from continuing to a subsequent step of the plurality of sequential steps for performing the test when the operating procedure has not been met for the respective sequential step.

Additionally or alternatively, the method further includes terminating the test.

Additionally or alternatively, terminating the test is only performed when the control device determines the operating procedure has been met for all respective sequential steps of the plurality of sequential steps for performing the test.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 depicts a schematic view of a rheological system in accordance with embodiments of the present invention.

FIG. 2 depicts a block diagram of a control device of the rheological system in accordance with embodiments of the present invention.

FIG. 3 depicts a method for controlling a rheological system in accordance with embodiments of the present invention.

FIGS. 4A and 4B depict exemplary screens for inputting a test operating procedure in accordance with embodiments of the present invention.

FIG. 5 depicts an exemplary touchscreen of a control device in accordance with embodiments of the present invention.

FIGS. 6A and 6B depict exemplary screens for verifying geometry in accordance with embodiments of the present invention.

FIG. 7A-7C depict exemplary screens for calibration in accordance with embodiments of the present invention.

FIG. 8A-8C depict exemplary screens for sample loading in accordance with embodiments of the present invention.

FIG. 9A-9D depict exemplary screens for a test in process and test completion in accordance with embodiments of the present invention.

FIGS. 10A and 10B depict exemplary screens for sample cleaning in accordance with embodiments of the present invention.

FIG. 11A-11G depict further methods for controlling a rheological system and displaying information to a user in accordance with embodiments of the present invention.

FIG. 12 depicts a block diagram of a computer system for the control device of FIGS. 1-2, capable of implementing methods for controlling a rheological system of FIGS. 3 and 11A-G, in accordance with embodiments of the present invention.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

In brief overview, embodiments of the invention relate to rheological systems and control systems for rheometers that provide improved rheology workflow. The rheological systems and/or rheometers may be referred to as instruments or an instrument. Embodiments of the present invention provides systems and methods that streamline complex rheology workflow, reduce operator error, and reduce deviations from operating procedure. Further, embodiments of the present invention provide systems and methods that allow for simple transfer of research and development methods to quality assurance/quality control testing, resulting in faster scale-up. The systems and methods may allow users/operators to perform complex testing in a simple and repeatable manner without requiring extensive training.

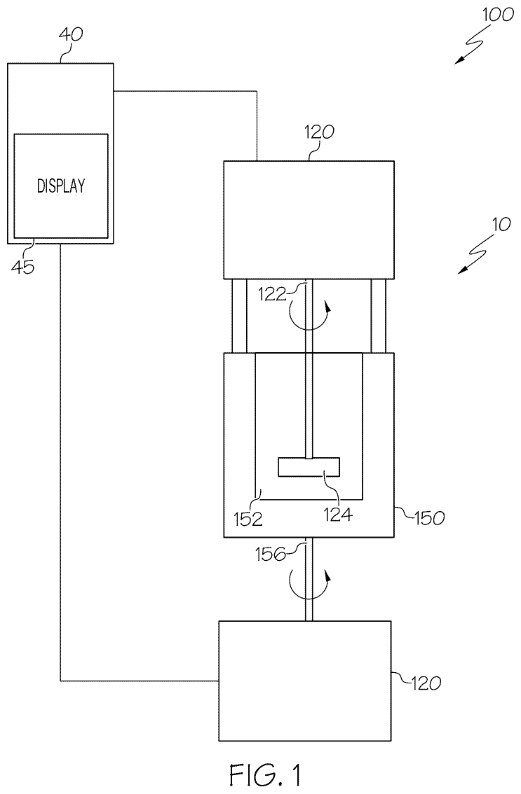

An exemplary rheological system is shown in FIG. 1. Specifically, FIG. 1 depicts a schematic view of a rheology system 100 having a rheometer 10 and a control device 40 in accordance with one embodiment.

The rheological system 100 and/or the rheometer 10 may be of a type known in the conventional art and/or may include features of a conventional system or device. Likewise, the control device 40 may be of a type known in the conventional art and/or may include features of a conventional device. Further, while the rheology system 100 includes various features described hereinbelow, it should be understood that the principles of the present invention may be applied to any rheological system/rheometer/instrument configured to measure rheological properties having fewer or more than the schematic components shown in FIG. 1.

As shown in the exemplary rheology system 100 of FIG. 1, the rheometer 10 may include a drive motor(s) and/or transducer(s) 120 having an output 122 and/or an output 156. A surrounding body 150 of a sample chamber 152 is shown attached to the output 156 of the drive motor, while a rotor 124 located within the sample chamber 152 is shown attached to the output 122 of the transducer(s) 120. In embodiments, the rheometer 10 may be configured to be used with additional attachments and/or components, for example, various geometry as discussed in more detail below.

As shown, the control device 40 is operably connected to the rheometer. In embodiments, the control device 40 may be incorporated into the rheometer 10. The control system 40 may be configured to generally control operation of the rheometer 10. For example, the control device 40 may be configured to control and monitor stresses, strains, forces, velocities, and the like, on components of the rheology system 100 and/or on a sample. The control device 40 may be configured to provide output information related to measurements conducted during testing of materials or samples within the sample chamber 152. The control device 40 may be configured to control motion of the outputs 122, 156. In embodiments, the control device 40 includes a display 45. In other embodiments, the display 45 may be included on the rheometer 10 or located in other positions within the rheological system 100. Still further, a separate computing device, for example, a computer, a laptop, a tablet, a mobile device, or a similar device may be used as the display. In embodiments, the display 45 may be configured as a touchscreen display.

The control device 40 may be incorporated into computer systems within the rheology system described hereinabove. Thus, the control device 40 may be a computerized control device including one or more processors, memory, data storage, and the ability to execute the various computer applications and algorithms described herein. Further, the control device may be applied to various types of rheological systems and material testing systems, including for example, rheometers, vertical material testing systems, horizontal material testing systems, viscometers, and the like.

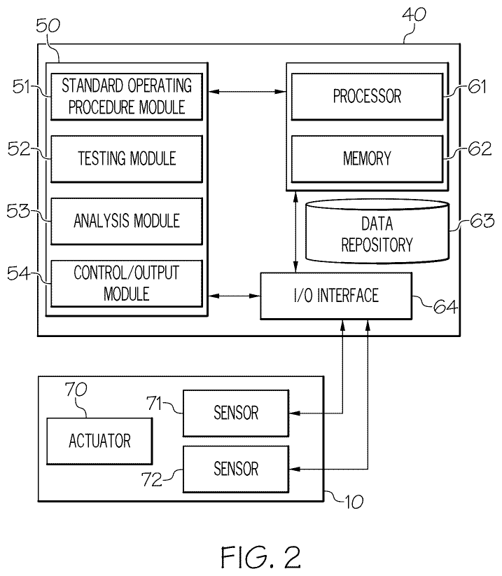

FIG. 2 depicts a block diagram of a control device 40 connected to the rheometer 10 in accordance with embodiments of the present invention. It will be understood that the control device 40 may be connected to the rheometer 10, may be a part of the rheological system 100, and/or may otherwise be configured to control the rheological system 100 and/or the rheometer 10.

As shown, the rheometer 10 includes one or more actuators 70 configured to perform actions as part of a testing process, for example, to exact force on a sample. The actuators 70 may include motors or other movement systems for creating movement or force. The actuators 70 may also include components for changing operating parameters of the rheometer, for example, temperature, pressure, and other parameters. In embodiments, the actuators 70 may be configured to act on the attachments or components such as the geometry. The rheometer 10 is further shown including two sensors 71, 72. The sensors 71, 72 may be displacement sensors, rotational sensors, force sensors, sensors related to the power output of the motor, or any other type of sensor configured to monitor the testing process and/or the sample. Still further, the sensors 71, 72 may include components for measuring or monitoring the operating parameters, for example, temperature, pressure, and the like. While two sensors 71, 72 are shown, it should be understood that any number of sensors are contemplated. Whatever the embodiment, one or more of the sensors 71, 72 of the rheometer 10 may be communicatively coupled to the control device 40 and may provide data thereto.

The sensors 71, 72 may be connected via an I/O interface 64 to the control device 40. The I/O interface 64 may refer to any communication process performed between the sensors 71, 72 and the control device 40. Input provided by the sensors 71, 72 to the control device 40 may refer to signals or instructions sent to the control device 40, for example data signals collected by the sensors 71, 72, while output may refer to signals sent out from the control device 40 to the rheometer 10, such as a signal to actuate the actuator 70 of the rheometer 10, to take other action as part of the testing process, to prevent an action, and the like. While the sensors 71, 72 are shown connecting specifically to the control device 40, it should be understood that the sensors 71, 72 may also be connected to the rheological system 100 in other configurations.

Furthermore, embodiments of the control device 40 may be equipped with memory 62 which may temporarily store various data/information/code, and a processor 61 for implementing the tasks associated with the control device 40. Further, the control device 40 may include a data repository 63 for long term storage of data received, and models created, by the control device 40.

As shown, a rheology workflow application 50 is loaded in the memory 62 of the control device 40. Thus, the control device 40 may further include an operating system, which can be a computer program for controlling an operation of the control device 40, the rheometer 10, and/or the rheological system, wherein rheology workflow applications loaded onto the control device 40 may run on top of the operating system to provide various functions. Furthermore, embodiments of the control device 40 may include the rheology workflow application 50. Embodiments of the rheology workflow application 50 may be an interface, an application, a program, a module, or a combination of modules.

While the depicted embodiment shows that rheology workflow application 50 is run from a computer system housed within the rheological system 100, other embodiments are contemplated. For example, the control device 40 may be incorporated into a computer system that is connected to the rheological system 100. Alternatively, the control device 40 may be located on a device connected to the rheological system 100 and/or the rheometer 10 over a network (wired or wireless). In still other embodiments, the control device 40 may be a cloud service connectable to the rheological system 100 and/or the rheometer 10.

The rheology workflow application 50 of the control device 40 may include a standard operating procedure module 51, a testing module 52, an analysis module 53, and an output/control module 54. A “module” may refer to a hardware-based module, software-based module or a module may be a combination of hardware and software. Embodiments of hardware-based modules may include self-contained components such as chipsets, specialized circuitry and one or more memory devices, while a software-based module may be part of a program code or linked to the program code containing specific programmed instructions, which may be loaded in the memory device of the control device 40. A module (whether hardware, software, or a combination thereof) may be designed to implement or execute one or more particular functions or routines.

Embodiments of the standard operating procedure module 51 may include one or more components of hardware and/or software program code configured for receiving, gathering, and/or processing data related to a standard operating procedure for a test or multiple tests to be conducted by the rheological system 100 and/or the rheometer 10, i.e., by the instrument. In embodiments the standard operating procedure module 51 may allow for input from an individual, for example, a lab manager or other individual, wherein the input sets criteria, conditions, and the like for respective tests. The input may also set steps of the test, for example, sequential steps to be taken to perform the test. Moreover, the operating procure module 51 may allow for input that sets pass/fail conditions for the test, termination conditions for the test, cleaning steps for the test, and the like. In embodiments, the standard operating procedure module 51 may be configured to receive such information from a different source, i.e., another computer program or application, a memory, a data repository, etc. The standard operating procedure module 51 may further be configured to provide received data into the data repository 63 for permanent data storage.

The control device 40 may further include the testing module 52. Embodiments of the testing module 52 may include one or more components of hardware and/or software program code configured for determining, tracking, and/or monitoring a test to be performed by the rheological system 100 and/or the rheometer 10. For example, the testing module 52 may be configured to receive a selection of a test from a user of the rheological system 100 and/or the rheometer 10. In embodiments, the testing module 52 may match the test with corresponding information from the standard operating module 51, for example, with the criteria, conditions, and the like for the respective test. Still further, the testing module may track and/or monitor steps taken by the user, the rheological system 100, and/or the rheometer 10 as the respective test is performed.

In embodiments, the control device 40, the rheology workflow application 50, and/or the testing module 52 may be configured to receive the operating procedure for a test. The operating procedure may include information input, retrieved, or provided to or by the operating procedure module 51 as discussed above. For example, the operating procedure may include the criteria, conditions, and the like for respective tests. The operating procedure may also include the steps to be performed as part of the test. For example, in embodiments, the operating procedure may include a plurality of sequential steps.

The control device 40 may further include the analysis module 53. Embodiments of the analysis module 53 may include one or more components of hardware and/or software program code configured for detecting or determining deviations between information from the standard operating procedure module 51 and the testing module 52. For example, as will be explained in more detail below, the analysis module may detect or determine that a property or setting of the rheometer 10 and/or of a sample to be tested does not match the criteria, conditions, and the like for the respective test set by the standard operating procedure and/or may detect or determine whether a step has been or is being performed. Still further, the analysis module may be configured for determining a result of a test, for example, a pass/fail result or an error result and/or may determine a completion of the test.

The control device 40 may further include the output/control module 54. Embodiments of the output/control module 54 may include one or more components of hardware and/or software program code configured for providing information to a user or an operator. For example, the output/control module 54 may be configured for outputting a warning, an error message, and/or an alert to the user or operator. Still further, the output/control module 54 may be configured for changing an operational parameter of the rheological system 100 and/or the rheometer 10 and/or for controlling the rheological system and/or the rheometer 10.

In embodiments, the output/control module 54 may be configured to provide information to the user/operator to an operator interface, such as a display like display 45, of the rheological system 100 and/or the rheometer 10. The output/control module 54 may also be configured to provide the information to the user/operator in other ways, for example, to other devices, such as a computer or mobile device, for example, a desktop, laptop, a tablet, a cell phone, a smart device, etc. For example, the output/control module 54 may receive information about the criteria, conditions, and the like for the respective test and may provide the information to the user. As a specific example, the output/control module 54 may provide information regarding a step or steps of the test to the user.

The operation of the control device 40, the rheology workflow application 50, and/or the individual modules 51-54 will now be described according to embodiments. It will be understood that various steps or actions may be taken by different components either alternatively or cooperatively. For example, a step or action that is described as taken or performed by the control device 40 may be understood to be taken or performed by a respective module and vice versa.

In embodiments, the control device 40, the rheology workflow application 50, and/or the standard operating procedure module 51 may be configured to receive an operating procedure for a test. As discussed above, the operating procedure may include criteria or conditions for the test and/or may comprise a plurality of steps to be performed as part of the test. In embodiments, the operating procedure may include a plurality of sequential steps. As discussed above, the plurality of steps may be set by a user, for example, a lab manager. In embodiments, the lab manager may input the steps using the control device 40, the rheology workflow application 50, the standard operating procedure module 51, or other devices. Still further, the steps may be retrieved from or provided by other devices. In this description, the term step, steps, plurality of steps, sequential steps, plurality of sequential steps, and the like, when used in reference to the operating procedure and/or the test, are intended to refer to any of these criteria, conditions, or steps of the operating procedure and/or test.

Examples of criteria, conditions, or steps from the operating procedure may include, but are not limited to, a setting or requirement of the rheological system 100 and/or the rheometer 10 and/or an action to be taken by the user, the rheological system 100 and/or the rheometer 10. As more specific examples, a step may include providing a component with a specific geometry, for example, a sample plate or concentric cylinder of a specific size; performing a calibration of the rheological system 100 and/or the rheometer 10; loading or trimming a sample; providing a specified gap for the sample; and providing a required cover for the sample. Still further, the operating procedure may include steps to be performed by the rheometer 10, for example, imparting or exacting a force or movement on a sample. The operating procedure may include a force or temperature threshold for the rheometer 10 and/or components thereof as well as positional requirements for the rheometer 10 and/or components thereof, for example, a height position requirement. In yet further embodiments, the operating procedure may include a cleaning requirement. It will be understood that any condition, criteria, setting, parameter or parameter may be considered a step. It will further be understood that any action, function, procedure, and the like to be taken by the user, the rheological system 100, and/or the rheometer 10 may be considered a step.

In embodiments, the control device 40, the rheology workflow application 50, and/or the output/control module 54 may be configured to present, for example, sequentially, the plurality of steps to a user of the rheometer. It will be understood that the steps may be provided through an operator interface, such as the display 45, or may be output in other form.

In embodiments, the control device 40, the rheology workflow application 50, and/or the output/control module 54 may be configured to control the rheological system 100 and/or the rheometer 10 according to the operating procedure to perform the test. Controlling the rheological system 100 and/or the rheometer 10 may include, but is not limited to, preventing rheological system 100, the rheometer 10, and/or the user from proceeding to a subsequent step of the plurality of sequential steps for performing the test, performing a step by the rheological system and/or the rheometer, terminating or completing a test, and the like. In embodiments, controlling may include presenting a subsequent step to the user and/or enabling a step to be performed.

In embodiments, the control device 40, the rheology workflow application 50, the testing module 52, and/or the analysis module 53 may be configured to determine whether the operating procedure has been met for a respective sequential step of the plurality of sequential steps for performing a respective test. Examples of determining whether the operating procedure has been met may include, but are not limited to, determining if a setting of the rheological system 100 and/or the rheometer 10 matches a setting indicated by the standard operating procedure; detecting an actual geometry of a component, for example, a sample plate or cylinder, and determining if the actual geometry of the component matches an expected geometry of the sample plate; and determining a calibration of the rheological system 100 and/or the rheometer 10 has been performed according to a calibration schedule indicated by the standard operating procedure. Further examples include determining if a sample loading requirement for a test has been met, determining if a trimming requirement has been met, determining if a gap control requirement has been met, and determining if a cover requirement has been met. Determining whether other requirements have been met may also be included. Still further examples include determining whether actions or functions have been performed, for example, loading a sample, imparting or exacting a force or movement on a sample, removing a sample, determining that a force or temperature threshold has been met, determining that a positional requirement, for example, a height position requirement has been met, and the like. In yet further examples, determining whether the operating procedure has been met includes determining if a cleaning requirement has been met.

In embodiments, the control device 40, the rheology workflow application 50, and/or the analysis module 53 may be configured to automatically determine a pass/fail result of the test. Automatically determining the pass/fail result may include analyzing a test result with pass/fail criteria included in the standard operating procedure.

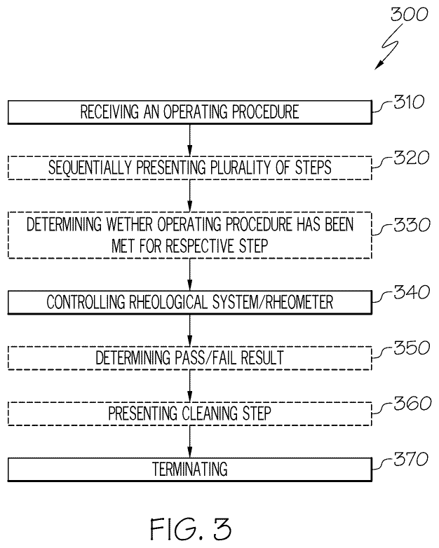

Various methods are contemplated for controlling operation of a rheological system such as the rheological system 100 and/or a rheometer such as the rheometer 10. For example, FIG. 3 depicts an exemplary method according to embodiments of the invention and as explained in more detail below.

FIG. 3 depicts a method 300 for controlling a rheological system/rheometer/instrument, in accordance with embodiments of the present invention. The method 300 is an exemplary method and may be performable by the rheological system 100, the rheometer 10, and/or the control device 40 as described hereinabove.

The method 300 includes a step 310 of receiving, by a control device, such as the control device 40, an operating procedure for a test. As described above, in embodiments the operating procedure may include a plurality of sequential steps for performing the test. Further, as described above, receiving may include receiving as an input from a user and/or a lab manager; receiving from a memory, data repository, or the like; and other forms of receiving information.

As shown in FIG. 3, the method may also include steps such as step 320 of sequentially presenting the plurality of steps of the operating procedure to the user and step 330 of determining whether the operating procedure has been met for a respective sequential step of the plurality of sequential steps for performing the test. In embodiments, these steps may be optional steps. Referring specifically to step 320, sequentially presenting the plurality of steps of the operating procedure may be performed through an operator interface, such as a display, or by outputting the plurality of steps in another form. Referring specifically to step 330, determining whether the operating procedure has been met may be performed as has been described above, for example, as described with respect to the testing module 52 and/or the analysis module 53.

The method 300 includes a further step 340 of controlling the rheological system, for example, the rheometer, according to the operating procedure to perform the test. As discussed above, controlling may include a variety of actions, including presenting information, changing an operating parameter, enabling an action or function, disabling an action or function, performing a test, completing a test, terminating a test, and the like. Specific examples may include presenting to the user a subsequent step of the plurality of sequential steps for performing the test only when the operating procedure has been met for the respective sequential step; providing a warning, an error message, and/or an alert to the user; preventing the rheometer and/or the user from continuing to a subsequent step of the plurality of sequential steps for performing the test; performing a calibration; proceeding to a subsequent step of the plurality of sequential steps for performing the test only when the operating procedure has been met for the respective sequential step; and the like.

The method may also include a step such as step 350 of determining, for example, automatically, a pass/fail result of the test. As described above, this determining may be based on the pass/fail criteria included in the operating procedure for the test. In embodiments, this step may be an optional step.

Still further, the method may also include a step such as step 360 of presenting a cleaning step. In embodiments, this step may be an optional step and/or may be included as part of step 320. Regardless of when the step occurs, presenting the cleaning step may include presenting a cleaning requirement as discussed above. In embodiments, the method may continue with a step such as step 330 of determining whether the operating procedure has been met for the respective sequential step of the plurality of sequential steps for performing the test, for example, determining whether the cleaning step has been met or has been performed.

The method may conclude with a final step 370 of terminating the test. In embodiments, the final step 370 may only be presented to the user upon determining that operating procedure has been met for all respective sequential steps of the plurality of sequential steps for performing the test, for example, determining that all previous steps have been performed. Such a determination may be made, for example, as part of a step such as step 330, as part of a further step of determining, and/or as part of a separate step or analysis.

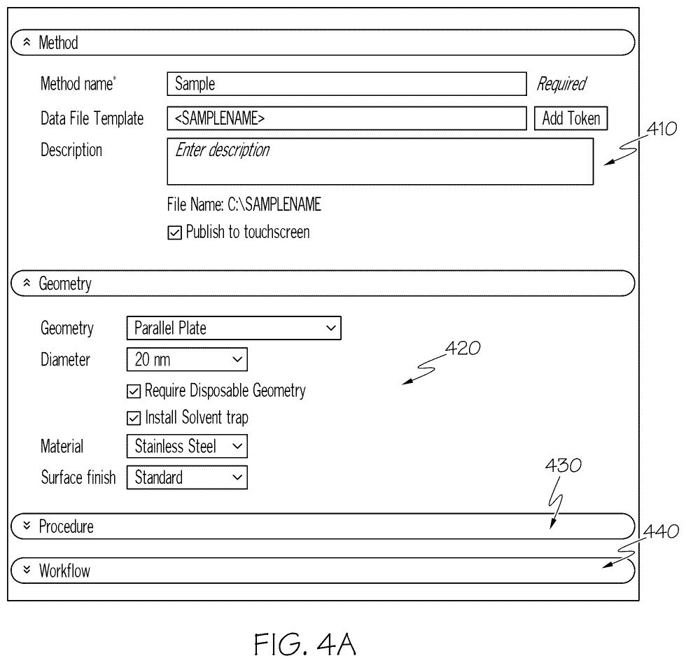

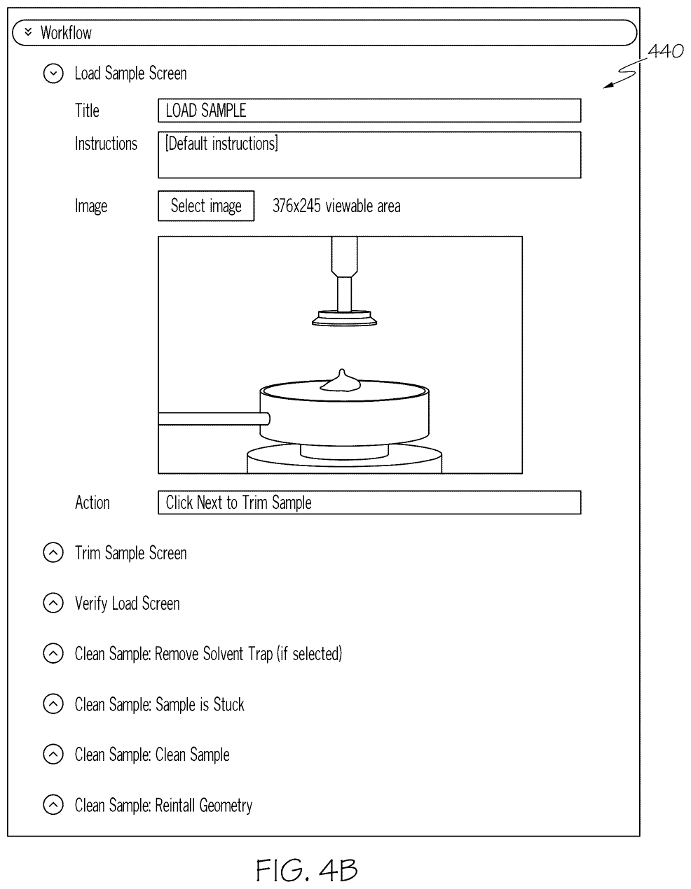

As discussed above, the rheological system 100, the rheometer 10, and/or the control device 40 may include a display, for example a touchscreen. Embodiments of the display are described in more detail with respect to FIG. 4A-10B.

It will be understood that the screens of FIG. 4A-10B are exemplary and are not intended to limit the invention to any specific layout or presentation. Each of the screens may include additional information or less information.

FIG. 4A depicts an exemplary screen for inputting a test operating procedure in accordance with embodiments of the present invention. As discussed above, in embodiments a user may input/edit a standard operating procedure for a test or multiple tests to be conducted by the rheological system 100 and/or the rheometer 10. As shown in FIG. 4A, the user, for example, the lab manager, may input information about the test or method to be performed in the fields generally designated by arrow 410, may input information about requirements for geometry and other settings in the fields generally designated by arrow 420, may input additional information about a procedure of the test or method in the fields generally designated by arrow 430, and/or may enter information about a workflow of the steps to be performed in the field generally designated by arrow 440. For example, as shown in the expanded workflow section 440 shown in FIG. 4B, various specific steps of the workflow may be input and/or edited, including steps related to sample loading, sample trimming, sample cleaning, and the like. It will be understood that additional information may be input and/or information may be retrieved from other sources.

FIG. 5 depicts an exemplary touchscreen of a control device in accordance with embodiments of the present invention. The exemplary touchscreen may be, for example, a home screen and/or start display of a rheological system, rheometer, and/or control device. The touchscreen may include general information such as an instrument name, manufacturer name, and similar information, presented for example, in the area designated by element 505. The touchscreen may also display multiple tests, for example Tests 1-6 as shown by elements 510a-510f. The user may select a test using the touchscreen. It will be understood that additional tests may be included, for example, by clicking arrow 520 to proceed to a different page of the display. In other embodiments, fewer tests may be included. The touchscreen may include additional information, including but not limited to, a settings button 530, a reset button 540, a stop button 550, and the like. The touchscreen may also display a current temperature 560, for example, 25.00° C., a height setting 561, for example, 200.000 mm, and/or other settings and parameters. The user may begin a test by tapping the play button for the respective test.

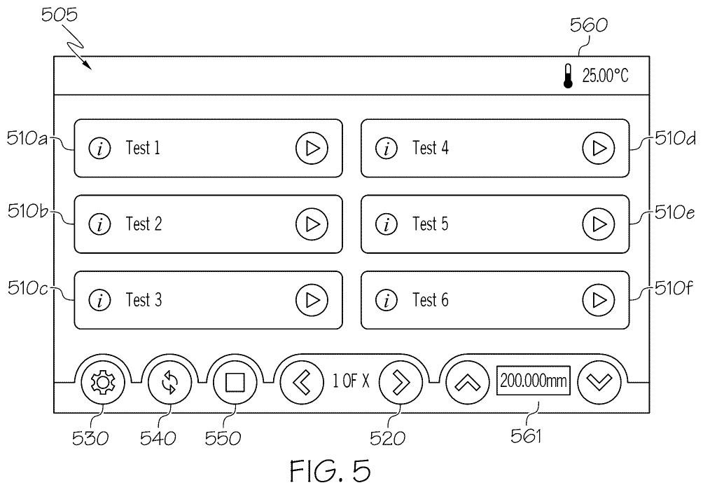

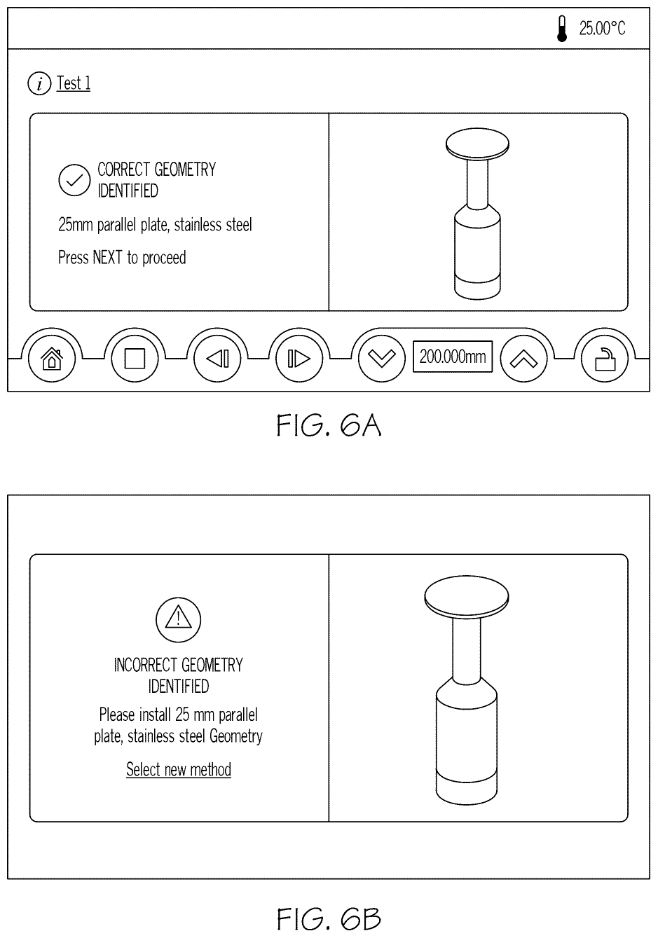

FIGS. 6A and 6B depict exemplary screens for verifying geometry in accordance with embodiments of the present invention. In embodiments, the actual geometry may be detected through reading a barcode, RFID or other connection, or other means. The detected actual geometry may then be compared with an expected geometry included in the operating procedure. FIG. 6A depicts an exemplary display of the touchscreen, for example, when a correct geometry is detected. In the depicted embodiment of FIG. 6A, an actual geometry, for example, of a 25 mm stainless steel parallel plate installed in the rheometer, matches an expected geometry set, for example, in the operating procedure. FIG. 6B shows a notification/warning issued when the detected actual geometry does not match the expected geometry. As explained above, the user and/or the rheometer may be prevented from proceeding to a further step due to the incorrect geometry. Instead, the user may remove the incorrect geometry and install a correct geometry. Alternatively, as shown in FIG. 6B, the user may be given the option to select a different test, for example, a test for which the detected actual geometry will match an expected geometry.

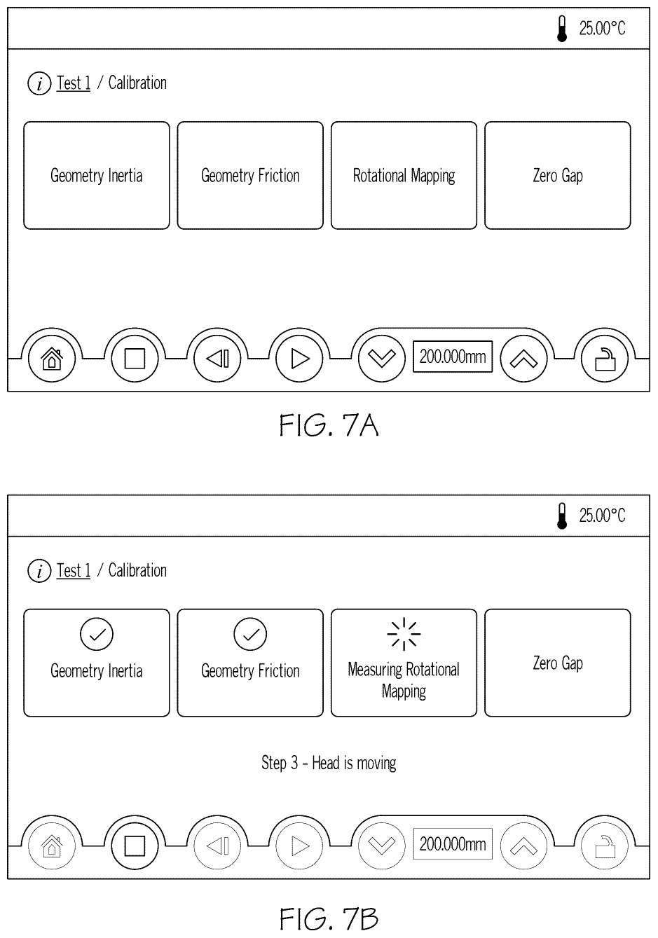

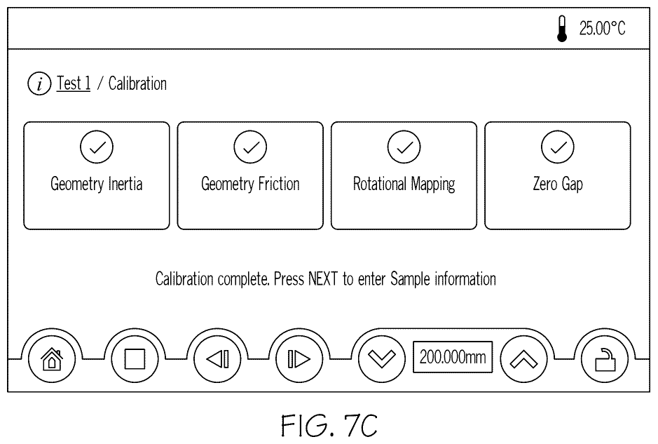

FIG. 7A-7C depict exemplary screens for calibration in accordance with embodiments of the present invention. FIG. 7A depicts an initial step of a calibration. The user may begin calibration by pressing the play button. As shown, the calibration may include a plurality of steps to calibrate the rheological system 100, the rheometer 10, or components thereof, including calibrating geometry inertia, calibrating geometry friction, calibrating rotational mapping, and calibrating a gap. As shown in FIG. 7B, the display may update as individual steps of the calibration are performed and completed. FIG. 7C shows completion of the calibration. Upon successful completion of calibration, the user and/or the rheometer may be permitted to proceed to subsequent steps, for example, by pressing a button to proceed to a step involving a sample to be tested.

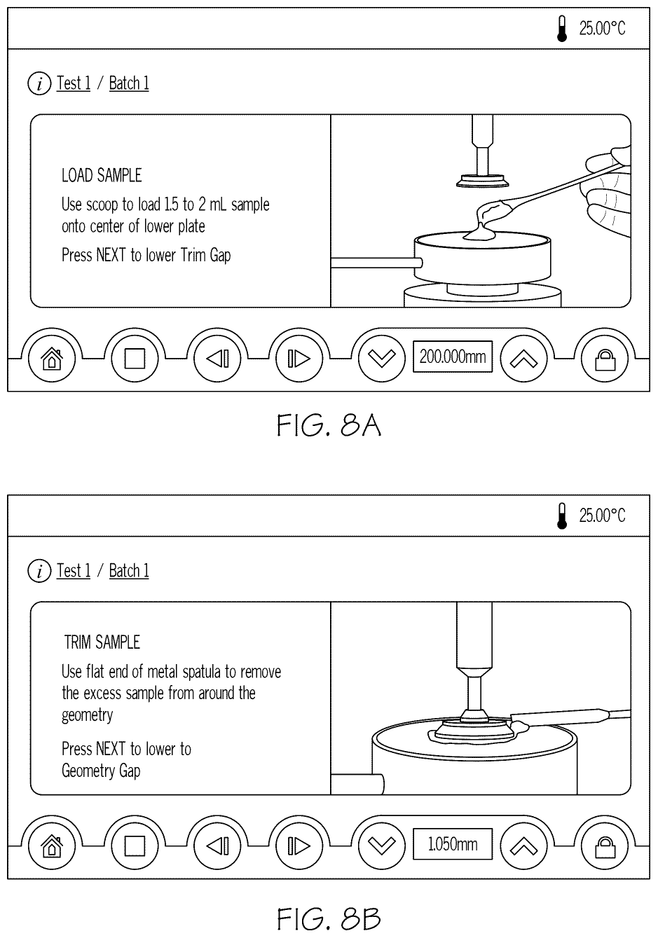

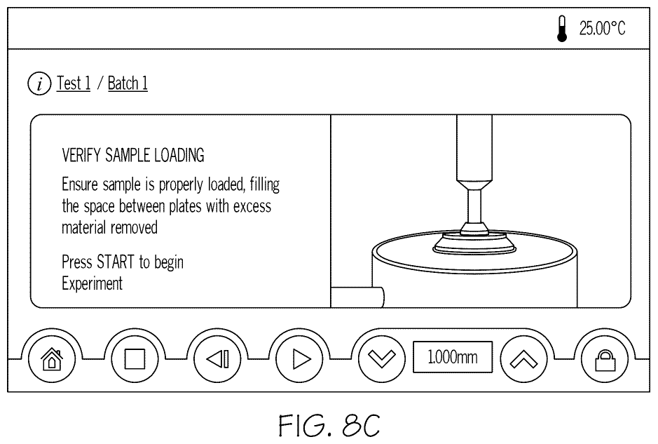

FIG. 8A-8C depict exemplary screens for sample loading in accordance with embodiments of the present invention. As shown in FIG. 8A, the display may include instructions to the user to load a sample using a utensil, for example, a scoop. The instructions may include an amount to be loaded, for example, 1.5 ml to 2 ml and/or instructions for where to place the sample, for example, onto the center of a lower plate of the rheometer 10. As shown in FIG. 8B, the display may include instructions to the user to trim the sample. The instructions may include what utensil to use, for example, a metal spatula, and how to perform the trimming, for example, removing excess material from around the geometry. As shown in FIG. 8C, the display may include instructions to verify that the sample is loaded, for example, loaded properly according to the operating procedure. For example, the display may include instructions instructing the user to confirm that the sample is loaded, fills any space between upper and lower plates, and that excess material has been removed. Upon completing these steps, the user and/or the rheometer may be permitted to proceed to subsequent steps, for example, by pressing a button to start an experiment, i.e., a test of the loaded sample.

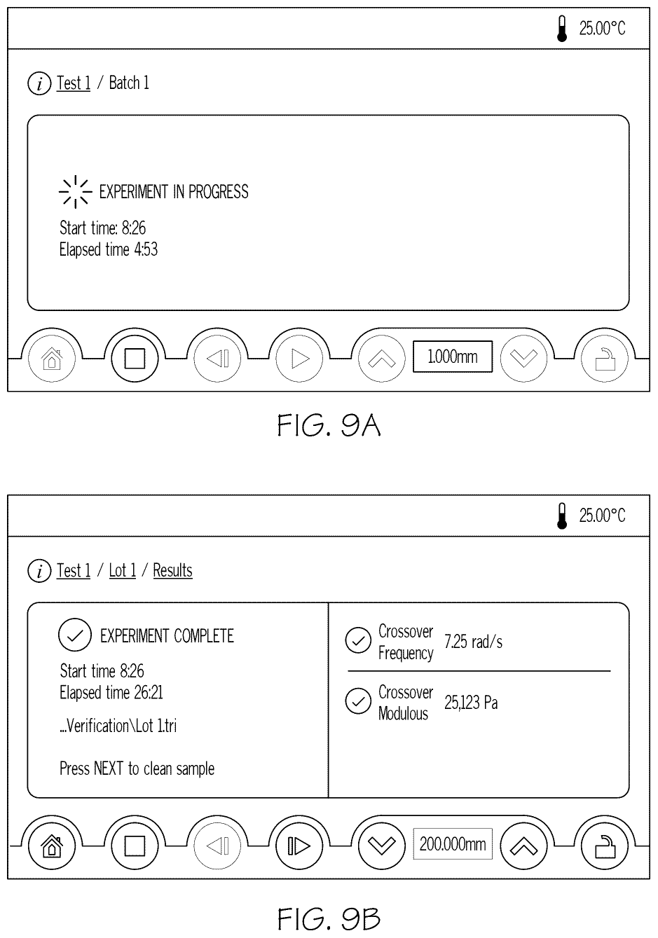

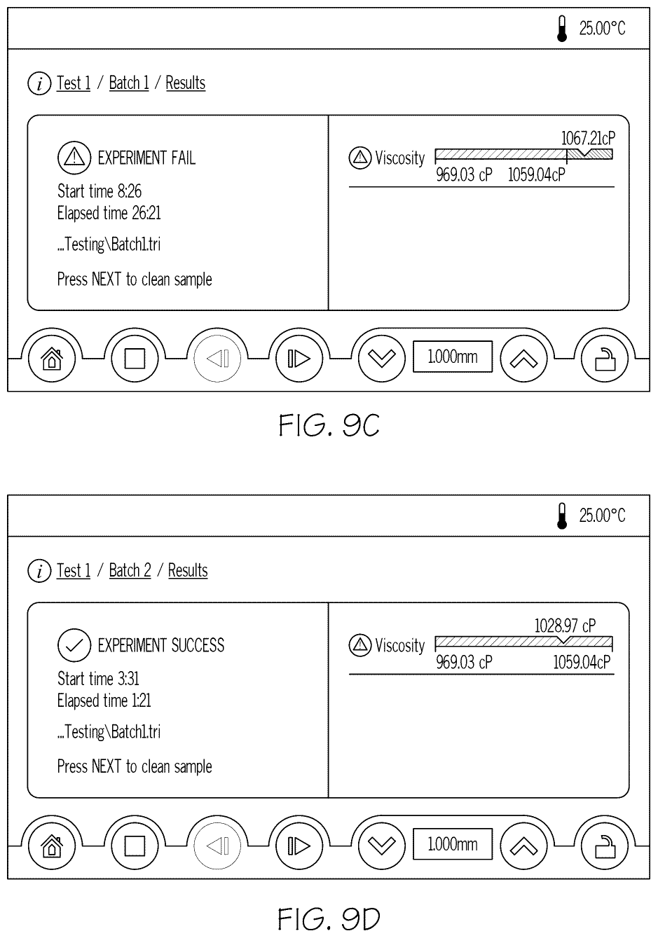

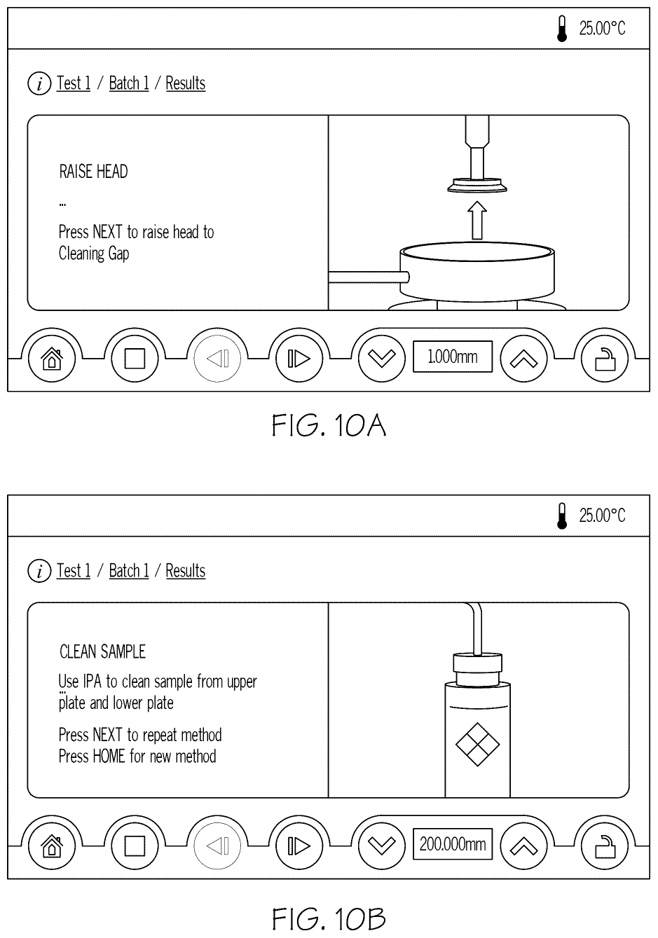

FIG. 9A-9D depict exemplary screens for a test in process and test completion in accordance with embodiments of the present invention. FIG. 9A depicts a test in process. As shown, the display may include a notification that an experiment or test is in process, may include a start time, may include an elapsed time, may include an option to stop or terminate the test, etc. FIG. 9B-9D depict exemplary screens for completed tests. In embodiments, the screen may indicate that the test or experiment has been completed as shown in FIG. 9B. Start time and elapsed time may be displayed along with other information related to the test or experiment, for example, parameters, values, etc. associated with the test or experiment. As shown in FIG. 9C, in some embodiments, the screen may indicate that the test or experiment failed. For example, the test or experiment may have been performed incorrectly and/or may have resulted in a value, for example a viscosity value, that is outside of a predetermined range set by the standard operating procedure. Still further, in embodiments the screen may indicate that the experiment was a success as shown in FIG. 9D. For example, the test or experiment may have been performed correctly and/or may have resulted in a value, for example a viscosity value, that is within the predetermined range set by the standard operating procedure.

As shown in FIGS. 9B-9D, after completion of the test or experiment, the screen may instruct the user to proceed to the next step, for example, a cleaning step.

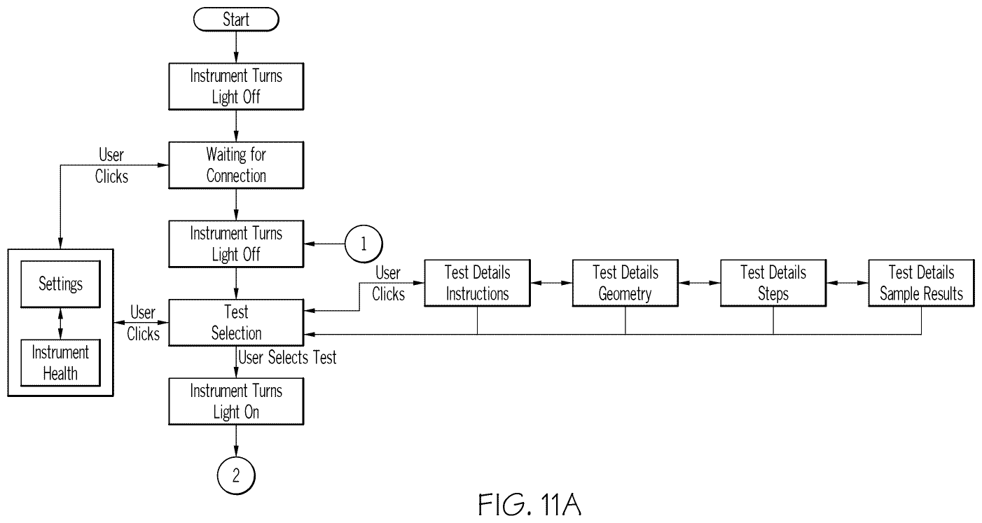

FIGS. 10A and 10B depict exemplary screens for sample cleaning in accordance with embodiments of the present invention. As shown in FIG. 10A, in embodiments, the cleaning step may include instructions for the user to raise the geometry, or head, of the rheometer 10 in order to clean the device, for example, to remove the sample and any residue. As shown in FIG. 10B, additional instructions may be provided to the user, including cleaning agents/solutions to be used or other steps to be taken. Still further, additional instructions for replacing/repositioning/reinstalling the geometry after cleaning may be provided.

It will be understood that in embodiments the cleaning step may include a determination or detection of an error. For example, a sample may become stuck and put undesired force or strain on the rheometer 10 or components thereof. In embodiments, the control device 40 may determine or detect that the sample is stuck based on a force detection, motor lock, or similar parameter. For example, a detected force may be compared with a predetermined threshold. The display may notify the user that the sample is stuck and provide instructions for remedying the issue. For example, the display may instruct the user to remove the geometry to avoid damage. As discussed above, after cleaning is performed, instructions may be provided to reinstall the removed geometry.

With reference still to FIG. 10B, following completion of the cleaning, the user and/or the rheometer may be permitted to repeat the test or to select a new test.

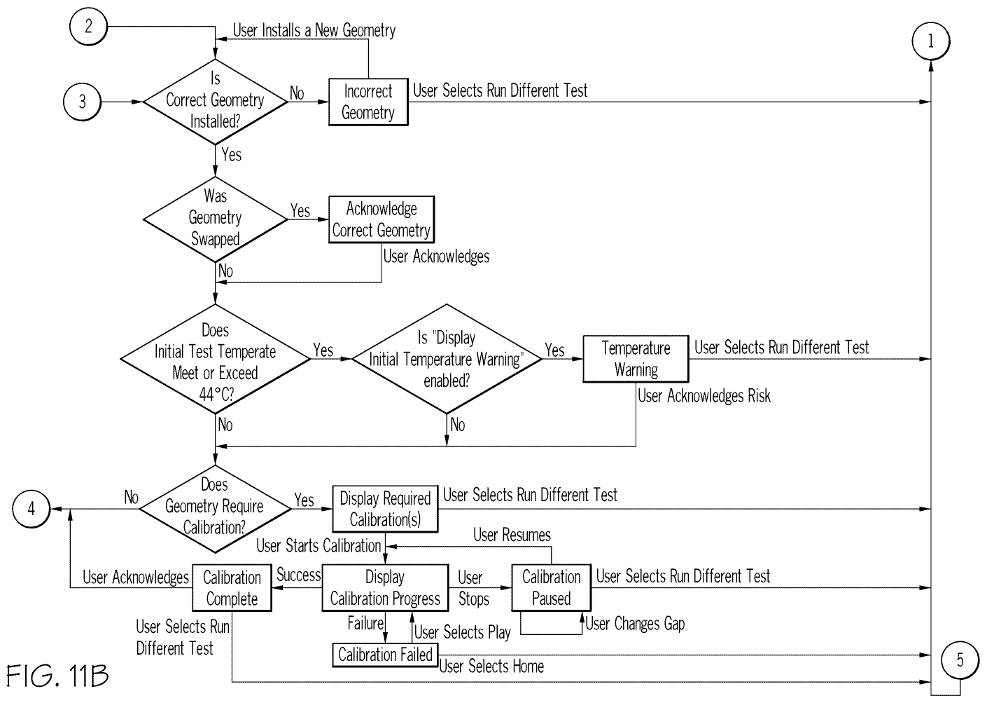

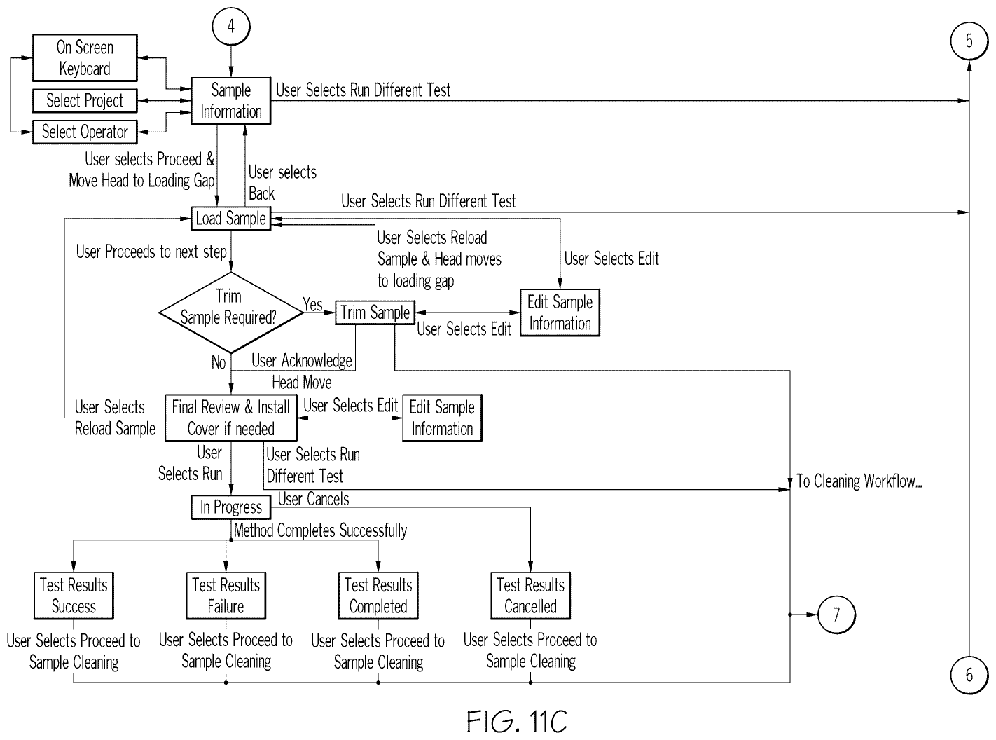

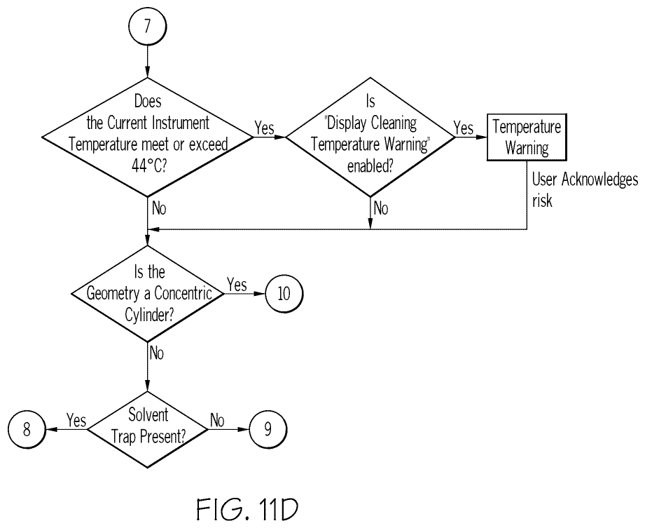

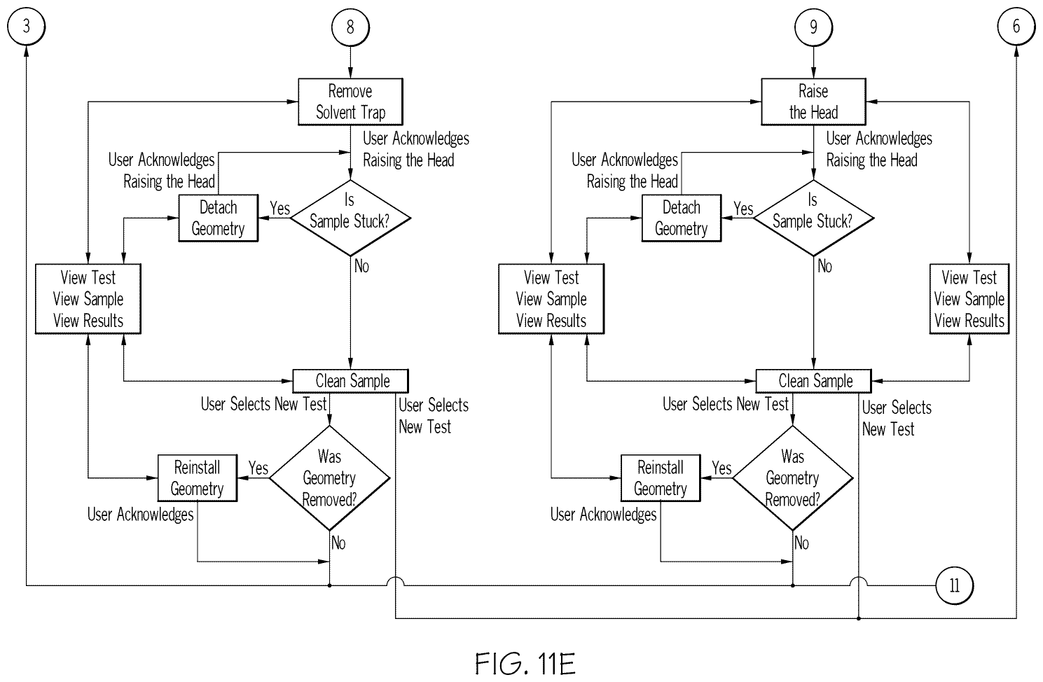

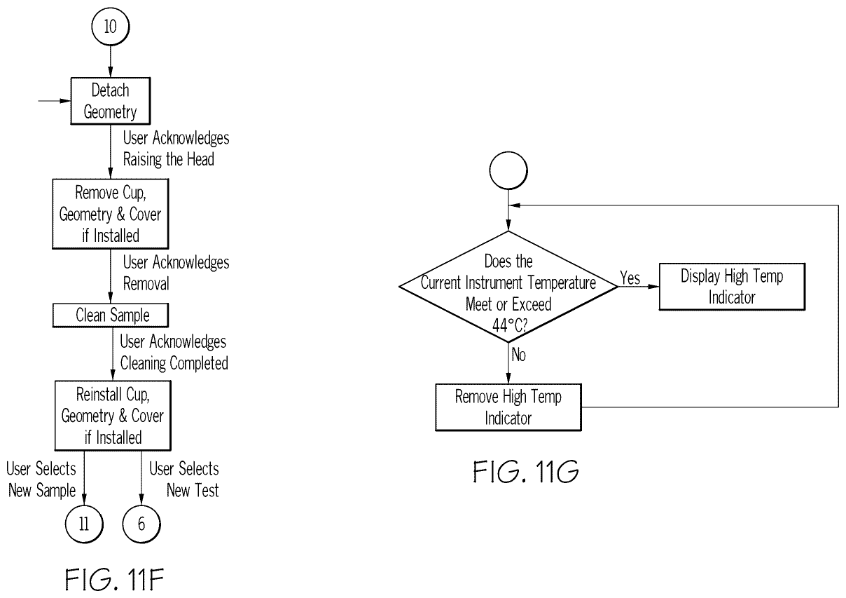

FIG. 11A-11G depict further exemplary methods for controlling a rheological system and displaying information to a user in accordance with embodiments of the present invention. The methods are described by way of exemplary touchscreen navigation workflow of the control system 40 and/or the display 45. These figures refer to an instrument—it will be understood that the instrument may be a rheological system, such as rheological system 100, and/or a rheometer, such as rheometer 10. It will further be understood that the instrument may have and/or may be connected to a control device such as control device 40.

As shown in FIG. 11A, in embodiments the method may include a start of the display, for example, following powering on or booting up of the instrument. After initial startup, instrument lights may be turned off. As shown, the method may also include steps of checking or determining instrument health, evaluating settings, and the like. The method may also include steps of waiting for a connection if a connection is not properly made upon start up. Again, instrument lights may be turned off while waiting. A user may access information about a test or experiment through the display. As shown in FIG. 11A and discussed in more detail above, various information regarding the test, including for example, instructions, geometry, detailed steps, may be displayed to the user to assist the user in making a selection of an appropriate test. As an example, the user may click on a touchscreen to access any of this additional information.

The user may then select a test, for example, a test or experiment as discussed above. In embodiments, instrument lights may turn on at this point as steps of the test or experiment begins. It will be understood that at any point in the method the user may return to this point (point 1) where the instrument lights are off and the user may access information about a test and/or select a test.

As shown in FIG. 11B, the user may install geometry for the test or experiment. For example, the user may be instructed, for example, by the display, to install geometry listed in the operating procedure. As discussed above, the method may include determining whether a correct geometry is installed (point 3), for example, whether an actual geometry matches an expected geometry from the operating procedure for the selected test. If an incorrect geometry is installed, the method may include actions discussed above, for example, preventing the user and/or the instrument from continuing to a next step, allowing the user to select a different test applicable to the installed geometry, and the like. For example, as depicted in FIG. 11B, the method may return to point 1 where the instrument lights are off and the user may access information about a test and/or select a test such that the user may select a test for which the installed geometry would be correct.

If correct geometry is installed, the method may proceed as shown. In embodiments, the method may include determining whether the geometry was swapped or changed, in which case the method may ask the user to acknowledge the correct geometry to confirm. If the geometry was not swapped and/or if the user acknowledges the correct geometry, the method may proceed as shown.

The method may include determining an initial temperature of the instrument. For example, in embodiments, 44° C. may be a threshold for a high temperature. When it is determined that the temperature exceeds 44° C., a high temperature indicator may be displayed, for example, if a warning feature is enabled. When a high temperature warning is displayed, the user may be given the option of selecting a different test applicable to the initial temperature. For example, as depicted in FIG. 11B, the method may return to point 1 where the instrument lights are off and the user may access information about a test and/or select a test. Alternatively, the user may be provided with information for a step to take to mitigate the high temperature. As discussed above, in embodiments, the method may include preventing other actions by the user and/or the instrument until the step to mitigate the high temperature is taken. Alternatively, the user may be allowed to acknowledge a risk associated with the high temperature. If the temperature does not exceed the threshold and/or if the user acknowledges the risk, the method may proceed as shown.

The method may include determining if calibration is required. If calibration is required, appropriate calibration steps may be provided to the user as discussed above. The user may opt to not perform calibration, for example, by terminating the test and/or by returning to point 1 where the instrument lights are off and the user may access information about a test and/or select a test. If the user proceeds with calibration, the method may include displaying calibration progress as discussed above, as well as confirming if calibration was successful or not. Calibration may also be stopped or paused if necessary or desired. In the case of unsuccessful calibration or stopped calibration, the method may return to point 1 where the instrument lights are off and the user may access information about a test and/or select a test. Upon completion of calibration, the user may opt to return to point 1 where the instrument lights are off and the user may access information about a test and/or select a test. Alternatively, the user may acknowledge completion of the calibration and the method may proceed as shown.

Referring now to FIG. 11C, the method may include presenting sample information for the test to the user, for example, by the display. As shown, the method may further include displaying an online keyboard, allowing the user to select a project, allowing the user to select an operator, and other features at this point. The user may also opt to terminate the test and/or select a different test by returning to point 1 where the instrument lights are off and the user may access information about a test and/or select a test. However, the user may elect to proceed by following instructions for loading the sample to be tested. For example, the user may select to proceed and perform sample loading as described in detail above.

Sample loading instructions may include instructions to position the sample on or with respect to the geometry. Sample loading may include moving a head of the instrument to a loading gap. The method may also include determining if trimming is required. If required, the user may be instructed to trim the sample and then to reload the sample and/or move the head to the loading gap. In embodiments, the user may select to edit the sample information if necessary. The user may also select to acknowledge the move of the head. The method may also include determining if a sample cover is needed and providing instructions for cover installation if necessary. Still further, the method may include a final review of the sample loading, for example to determine whether pertinent portions/steps of the operating procedure have been met. If review is not satisfactory, the method may include reloading the sample and repeating pertinent steps. Alternatively, the user may opt to terminate the test. In embodiments, the user may be permitted to select a new test at point 1 and/or may be instructed to proceed to a cleaning step as shown. If the review is satisfactory, the method may proceed as shown.

In embodiments, the method may include presenting the user with an option to run the test or experiment as shown. The test or experiment may then be carried out by the instrument. If necessary, the test may be cancelled by the user, in which case the user may be permitted to select a new test at point 1 and/or may be instructed to proceed to a cleaning step as shown.

As discussed above, the method may include determining a result of the test or experiment, for example, a completion, a pass/fail result, and the like. As shown, in embodiments, the test result may be a success, may be a failure, may be completed, and/or may be cancelled. In embodiments, the user may then select to proceed to sample cleaning as shown.

As shown in FIG. 11D, in embodiments, the method may include a determination of instrument temperature as an initial portion of the sample cleaning, for example, to ensure user safety during cleaning. For example, in embodiments, 44° C. may be a threshold for a high temperature. When it is determined that the temperature exceeds 44° C., a cleaning temperature warning may be displayed, for example, if a cleaning warning feature is enabled. When a high cleaning temperature warning is displayed, the user may be allowed to acknowledge a risk associated with the high cleaning temperature.

If the temperature does not exceed the threshold and/or if the user acknowledges the risk, the method may proceed by determining if the geometry is a concentric cylinder. If the geometry is not a concentric cylinder, the method may proceed by determining if a solvent trap is present. If a solvent trap is present, the method proceeds with the cleaning workflow shown on the left side of FIG. 11E (point 8). If a solvent trap is not present, the method proceeds with the cleaning workflow shown on the right side of FIG. 11E (point 9). If the geometry is a concentric cylinder, the method may proceed with the cleaning workflow shown in FIG. 11F (point 10).

Referring now to FIG. 11E, two exemplary cleaning workflows are shown, for example, a cleaning workflow beginning at point 9 and a solvent trap-specific cleaning workflow beginning at point 8. Referring first to the cleaning workflow beginning at point 9, the method may include a step of raising the head of the instrument. In embodiments, the user may acknowledge that the head has been raised. The method may include a step of determining if the sample is stuck, for example, stuck to the head and/or the geometry. If the sample is stuck, the method may include instructing the user to detach the geometry. The method may then include returning to the step of raising the head and determining if the sample is stuck. The method may then include cleaning the sample as shown. Referring now to the solvent trap-specific cleaning workflow beginning at point 8, the method may include a step of instructing the user to remove the solvent trap. In embodiments, the user may acknowledge that the head of the instrument has been raised. The method may include a step of determining if the sample is stuck, for example, stuck to the head and/or the geometry. If the sample is stuck, the method may include instructing the user to detach the geometry. The method may then include returning to the step of removing the solvent trap and determining if the sample is stuck. The method may then include cleaning the sample as shown.

In both the cleaning workflow beginning at point 9 and the solvent trap-specific cleaning workflow beginning at point 8, the method may include selecting a new sample (point 11) and/or selecting a new test (point 6) as shown. If the user selects a new sample (point 11), the method may include a step determining if the geometry was removed and, if so, instructing the user to reinstall the geometry. After reinstalling the geometry, or if geometry was not removed and does not need to be reinstalled, the method may proceed to determining if the geometry is correct (point 3) and may proceed as described above. If the user selects a new test (point 6) the method may include returning to the step of selecting a test or experiment (returning to point 1 by way of point 5).

FIG. 11F depicts an exemplary cleaning workflow beginning at point 10 for when the geometry is a concentric cylinder. In embodiments, the method may proceed by instructing the user to detach the geometry. In embodiments, the user may acknowledge that the head has been raised. The method may also include steps of removing any additional structures, such as a cup, other geometry, cover, and the like, if installed. The user may acknowledge removal. The method may then include cleaning the sample as shown. In embodiments, the user may acknowledge that cleaning is complete. The method may then include instructing the user to reinstall the geometry and any additional structures if needed. As with the other cleaning workflows, the cleaning workflow shown in FIG. 11F, may include selecting a new sample (point 11) and/or selecting a new test (point 6) as shown. If geometry was reinstalled, or if geometry was not removed and does not need to be reinstalled, the method may proceed to determining if the geometry is correct (point 3) and may proceed as described above. If the user selects a new test (point 6) the method may include returning to the step of selecting a test or experiment (returning to point 1 by way of point 5).

At any point in any of the cleaning workflows, the method may also include steps of displaying the test information, displaying the sample information, displaying the test results, and the like.

As shown in FIG. 11G, in embodiments the method may include determining a current instrument temperature. For example, in embodiments, 44° C. may be a threshold for a high temperature. When it is determined that the temperature exceeds 44° C., a high temperature indicator may be displayed. Further, the user may be provided with information for a step to take to mitigate the high temperature. As discussed above, in embodiments, a control device, such as control device 40, may prevent other actions by the user and/or the instrument, until the step to mitigate the high temperature is taken. When it is determined that the temperature does not exceed 44° C., for example, is reduced below the threshold, the high temperature indicator may not be displayed or may be removed. Further, the control device may enable the user and/or the instrument to proceed with subsequent steps.

With respect to FIG. 11A-11G, it will be understood that any step or any labeled point, the method may include controlling the instrument, for example, by preventing the instrument from proceeding to a subsequent step of the test and/or the operating procedure, performing a step of the test and/or the operating procedure, terminating or completing the test and/or the operating procedure, and the like. In embodiments, controlling the instrument may further include presenting a subsequent step of the test and/or the operating procedure to the user and/or enabling a step of the test and/or the operating procedure to be performed.

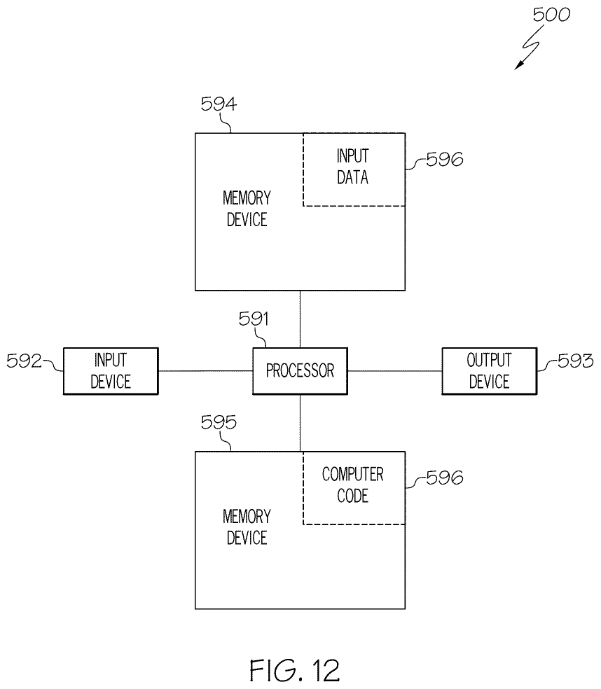

FIG. 12 depicts a block diagram of a computer system for rheological systems, rheometers, and control devices such as those of FIGS. 1 and 2, capable of implementing methods for controlling a rheological system, rheometer, or instrument such as those of FIGS. 3 and 11A-11G, and for use with control devices and displays such as those of FIGS. 4A-10B, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer system 500, including executing instructions included in the computer code 597 for the tools and programs capable of implementing a method controlling a rheological system, rheometer, or instrument such as that of FIG. 3 or FIG. 11A-11G using rheological systems, rheometers, and control devices such as those of FIGS. 1 and 2, wherein the instructions of the computer code 597 may be executed by processor 591 via memory device 595. The computer code 597 may include software or program instructions that may implement one or more algorithms for implementing the method for controlling a rheological system or rheometer, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer-readable program embodied therein and/or having other data stored therein, wherein the computer-readable program comprises the computer code 597. Generally, a computer program product (or, alternatively, an article of manufacture) of the computer system 500 may comprise said computer usable storage medium (or said program storage device).

Memory devices 594, 595 include any known computer-readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 11.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 63 as shown in FIG. 2.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to error compensation systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer system 500) including one or more processor(s) 591, wherein the processor(s) carry out instructions contained in the computer code 597 causing the computer system to detect changes in a material test. Another embodiment discloses a process for supporting computer infrastructure, where the process includes integrating computer-readable program code into a computer system 500 including a processor.

The step of integrating includes storing the program code in a computer-readable storage device of the computer system 500 through use of the processor. The program code, upon being executed by the processor, implements a method for detecting change in a material test. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for controlling a rheological system or a rheometer.

A computer program product of the present invention comprises one or more computer-readable hardware storage devices having computer-readable program code stored therein, said program code containing instructions executable by one or more processors of a computer system to implement the methods of the present invention.

A computer system of the present invention comprises one or more processors, one or more memories, and one or more computer-readable hardware storage devices, said one or more hardware storage devices containing program code executable by the one or more processors via the one or more memories to implement the methods of the present invention.

The present invention may be a system, a control device, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been shown and described with reference to specific embodiments, it should be understood by those skilled in the art that various changes in form and detail may be made therein without departing from the spirit and scope of the invention as recited in the accompanying claims.

What is claimed is:

1. A method of controlling a rheometer, comprising:
receiving, by a control device, an operating procedure for a test, the operating procedure including a plurality of sequential steps for performing the test; and
controlling the rheometer according to the operating procedure to perform the test, wherein controlling includes:
sequentially presenting, to a user of the rheometer, the plurality of sequential steps,
determining whether the operating procedure has been met for a respective sequential step of the plurality of sequential steps for performing the test, and
proceeding to a subsequent step of the plurality of sequential steps for performing the test only when the operating procedure has been met for the respective sequential step.

2. The method of claim 1, wherein controlling the rheometer according to the operating procedure to perform the test further includes providing a warning, an error message, and/or an alert when the operating procedure has not been met for the respective sequential step.

3. The method of claim 1, wherein controlling the rheometer according to the operating procedure to perform the test further includes preventing the rheometer from continuing to a subsequent step of the plurality of sequential steps for performing the test when the operating procedure has not been met for the respective sequential step.

4. The method of claim 1, further comprising:
terminating the test.

5. The method of claim 4, wherein terminating the test is only performed when the control device determines the operating procedure has been met for all respective sequential steps of the plurality of sequential steps for performing the test.

6. A rheological system, comprising:
a rheometer; and
a control device for controlling the rheometer according to an operating procedure to perform a test, the control device including one or more processors, the control device configured to:
receive the operating procedure for the test, the operating procedure including a plurality of sequential steps for performing the test,
sequentially present, to a user of the rheometer, the plurality of sequential steps,
determine whether the operating procedure has been met for a respective sequential step of the plurality of sequential steps for performing the test, and
proceed to a subsequent step of the plurality of sequential steps for performing the test only when the operating procedure has been met for the respective sequential step.

7. The rheological system of claim 6, wherein when the operating procedure has not been met for the respective sequential step, the control device is configured to provide a warning, an error message, and/or an alert to the user.

8. The rheological system of claim 6, wherein when the operating procedure has not been met for the respective sequential step, the control device is configured to prevent the rheometer and/or the user from continuing to a subsequent step of the plurality of sequential steps for performing the test.

9. The rheological system of claim 6, wherein the control device is further configured to terminate the test.

10. The rheological system of claim 9, wherein the control device is configured to terminate the test only when the control device determines the operating procedure has been met for all respective sequential steps of the plurality of sequential steps for performing the test.

11. The rheological system of claim 6, wherein the operating procedure includes an expected geometry of a sample plate for the test, wherein the rheometer and/or the control device are configured to detect an actual geometry of the sample plate, and wherein the control device is also configured to perform at least one action selected from the group consisting of:
present to the user a subsequent step of the plurality of sequential steps only when the actual geometry matches the expected geometry;
provide a warning, an error message, and/or an alert to the user when the actual geometry does not match the expected geometry; and
prevent the rheometer and/or the user from continuing to a subsequent step of the plurality of sequential steps for performing the test when the actual geometry does not match the expected geometry.

12. The rheological system of claim 6, wherein the operating procedure includes a calibration schedule for the rheometer and/or the rheological system and wherein the control device is also configured to perform at least one action selected from the group consisting of:
prevent the rheometer and/or the user from continuing to a subsequent step of the plurality of sequential steps for performing the test until calibration is performed according to the calibration schedule;
present to the user a subsequent step of the plurality of sequential steps only when calibration is successfully performed according to the calibration schedule;
provide a warning, an error message, and/or an alert to the user when calibration is not performed according to the calibration schedule; and
prevent the rheometer and/or the user from continuing to a subsequent step of the plurality of sequential steps for performing the test when calibration is not performed according to the calibration schedule.

13. The rheological system of claim 6, wherein the operating procedure for the test further includes pass/fail criteria for the test, wherein the control device is configured to automatically determine a pass/fail result of the test based on the pass/fail criteria for the test, and wherein the control device is configured to provide the automatically determined pass/fail result of the test to the user.

14. The rheological system of claim 6, wherein the operating procedure for the test includes a sample loading requirement for a sample of the test and wherein the control device is also configured to perform at least one action selected from the group consisting of:
prevent the rheometer and/or the user from continuing to a subsequent step of the plurality of sequential steps for performing the test until the sample is loaded according to the sample loading requirement for the test;
present to the user a subsequent step of the plurality of sequential steps only when the sample is properly loaded according to the sample loading requirement for the test;
provide a warning, an error message, and/or an alert to the user when the sample is not loaded and/or is not loaded according to the sample loading requirement; and
prevent the rheometer and/or the user from continuing to a subsequent step of the plurality of sequential steps for performing the test when the sample is not loaded and/or is not loaded according to the sample loading requirement.

15. The rheological system of claim 6, wherein the operating procedure for the test includes a cleaning requirement for the test and wherein the control device is also configured to perform at least one action selected from the group consisting of:
prevent the rheometer and/or the user from continuing to a subsequent step of the plurality of sequential steps for performing the test and/or from completing the test until the cleaning requirement for the test is met;
present to the user a subsequent step of the plurality of sequential steps and/or an option to complete the test only when the cleaning requirement for the test is met;
provide a warning, an error message, and/or an alert to the user when the cleaning requirement for the test is not met; and
prevent the rheometer and/or the user from continuing to a subsequent step of the plurality of sequential steps for performing the test and/or from completing the test when the cleaning requirement for the test is not met.

16. The rheological system of claim 6, wherein the rheometer and/or the control device are configured to detect a force on the rheometer or a component of the rheometer, wherein the control device is configured to compare the force with a predefined threshold, and wherein when the force exceeds the predefined threshold the control device is configured to provide a warning, an error message, and/or an alert to the user.

17. The rheological system of claim 6, wherein the rheometer and/or the control device are configured to detect a height position of a component of the rheometer, wherein the control device is configured to compare the height position with a predefined value, and wherein when the height position deviates from the predefined value the control device is configured to provide a warning, an error message, and/or an alert to the user.

18. The rheological system of claim 6, wherein the operating procedure includes an expected geometry of a sample plate for the test, wherein the rheometer and/or the control device are configured to detect an actual geometry of the sample plate, wherein the operating procedure for the test also includes a sample loading requirement for a sample of the test to be loaded on the sample plate for the test, and wherein the control device is also configured to perform at least one action selected from the group consisting of:
prevent the rheometer and/or the user from continuing to a subsequent step of the plurality of sequential steps for performing the test unless the actual geometry matches the expected geometry and the sample is loaded according to the sample loading requirement for the test;
present to the user a subsequent step of the plurality of sequential steps only when the actual geometry matches the expected geometry and the sample is properly loaded according to the sample loading requirement for the test;
provide a warning, an error message, and/or an alert to the user when the actual geometry does not match the expected geometry or the sample is not loaded according to the sample loading requirement; and
prevent the rheometer and/or the user from continuing to a subsequent step of the plurality of sequential steps for performing the test when the actual geometry does not match the expected geometry or the sample is not loaded according to the sample loading requirement.

19. The rheological system of claim 6, wherein the operating procedure for the test includes a cleaning requirement for the test, wherein the cleaning requirement includes a height requirement of a component of the rheometer, wherein the rheometer and/or the control device are configured to detect a height of the component and a force on the rheometer or the component, and wherein the control device is also configured to:
determine that a sample has become stuck based on the height of the component and the force on the rheometer or the component,
provide a warning, an error message, and/or an alert to the user, wherein the warning, error message, and/or alert include instructions for further cleaning to clean the sample that has become stuck.

20. A rheological system, comprising:
a rheometer; and
a control device, the control device including one or more processors, the control device configured to:
receive an operating procedure for a test, the operating procedure including a plurality of sequential steps for performing the test,
sequentially present, to a user of the rheometer, the plurality of sequential steps, and
control the rheometer according to the operating procedure to perform the test.
